(19) United States
(12) Patent Application Publication
(10) Pub. No.: US 2007/0236946 A1
(43) Pub. Date: Oct. 11, 2007

(54) Lighting Assembly Having An Integrated Solid-State Light Emitting Device

(76) Inventors: John Petrakis, St. Charles, IL (US); Charles F. Huber, Lake Forest, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,081

(22) Filed: Mar. 30, 2006

(51) Int. Cl. F21V 21/00

(52) U.S. Cl. 362/374; 362/253; 362/230; 362/276; 362/378

(57) ABSTRACT

A lighting assembly comprising a socket housing having a lamp socket electrically connected to an electrical junction, a trim removably attached to the socket housing about its opening; and one or more solid-state light emitting device associated with the trim. The one or more solid-state light emitting devices may be inconspicuous to the casual observer when they are not illuminated. The one or more solid-state light emitting devices are operatively connected to the electrical junction such that they can receive electrical power when the electrical junction is operatively connected to mains power. The connection between the LEDs and the junction may be controlled manually, by a backup power supply circuit, motion detector, or light detector to provide, among other possibilities, mood lighting, backup lighting or work lighting, in addition to the light provided by a lamp in the socket.

### FIELD OF THE INVENTION

The present invention relates in general to lighting fixtures, in particular, to a lighting fixture assembly having a primary lighting source and a solid-state light emitting device operating independently of the primary lighting source.

### BACKGROUND OF THE INVENTION

The most common use of light emitting device technology is found in life safety products, such as exit signs, path or step lighting. The benefits of their use include, condensed packaging, longer lamp life, and greater light output per device when compared with traditional light bulbs, such as incandescent or compact halogen bulbs. Unlike conventional line voltage incandescent light sources, a solid-state light emitting device typically requires some form of power converter or transformer to energize the device. Several conventional recessed light fixtures have been developed to use a cluster of solid-state light emitting devices as the primary light source for the light fixture. These conventional recessed light fixtures utilize a power converter or transformer in lieu of a conventional incandescent lamp socket. An incandescent replacement bulb has also been developed that has a cluster of solid-state light emitting devices and an LED driver having a power converter terminal adapted to mate with a conventional incandescent bulb socket. However, solid-state light emitting devices have not been integrated into recessed lighting products to operate independently of the primary lighting source to provide additional lighting functionality.

### SUMMARY OF THE INVENTION

In accordance with articles of manufacture consistent with the present invention a lighting assembly is provided. The lighting assembly comprises a socket housing defining an opening and having a lamp socket disposed therein; the lamp socket being electrically connected to an electrical junction and adapted to receive a primary lighting source; a trim removably attached to the socket housing about the opening; and a first solid-state light emitting device mounted to the trim. The first solid-state light emitting device being operatively connected to the electrical junction such that it is capable of receiving a current or electrical power to cause the first solid-state emitting device to emit light when the electrical junction is operatively connected to mains power. In one aspect, the solid-state light emitting device is mounted to the trim such that when the lighting assembly is installed the solid-state light emitting device is inconspicuous to the casual observer.

In addition, in accordance with articles of manufacture consistent with the present invention, a trim for a lighting assembly is provided. The lighting assembly comprises a first connector, a socket housing having an opening and a lamp socket disposed therein. The first connector and the lamp socket are each electrically connected to an electrical junction. The trim comprises: a first solid-state light emitting device mounted to the trim; and a second connector operatively connected to mate to the first connector such that the first solid-state light emitting device is capable of receiving a current or electrical power to cause the first solid-state light emitting device to emit light when the electrical junction is operatively connected to mains power.

In accordance with methods consistent with the present invention, a method is provided for providing alternative lighting from a lighting product. The lighting product comprises a socket housing having an opening and a lamp socket disposed therein. The lamp socket is electrically connected to an electrical junction. The method comprises: providing a trim having a first solid-state light emitting device mounted thereto; attaching the trim to the opening of the socket housing; and operatively connecting the first solid-state light emitting device to the electrical junction.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is an elevational cross-section view of an exemplary lighting assembly suitable for implementing the present invention, wherein the lighting assembly has a solid-state light emitting device operatively configured to operate in association with a lamp installed in a lamp socket of the lighting assembly;

FIG. 2 is perspective cross-sectional view of another exemplary lighting assembly suitable for implementing the present invention, wherein the lighting assembly has a solid-state light emitting device operatively configured to operate in association with a lamp installed in a lamp socket of the lighting assembly;

FIG. 3A is a schematic representation depicting one embodiment for supplying mains power to the lamp socket and the solid-state light emitting device of the lighting assembly in accordance with the present invention;

FIG. 3B is a schematic representation depicting another embodiment for supplying mains power to the lamp socket and the solid-state light emitting device of the lighting assembly in accordance with the present invention;

FIG. 4 is a block diagram depicting one embodiment of a switching device for use in the circuit of FIG. 3A or 3B in accordance with the present invention;

FIG. 5 is a block diagram depicting another embodiment of a switching device for use in the circuit of FIG. 3A or 3B in accordance with the present invention; and

FIG. 6 is a block diagram depicting one embodiment of a battery backup for supplying a current or electrical power to the solid-state light emitting device of the light assembly in FIG. 1 or 2 in accordance with the present invention.

### DETAILED DESCRIPTION OF THE INVENTION

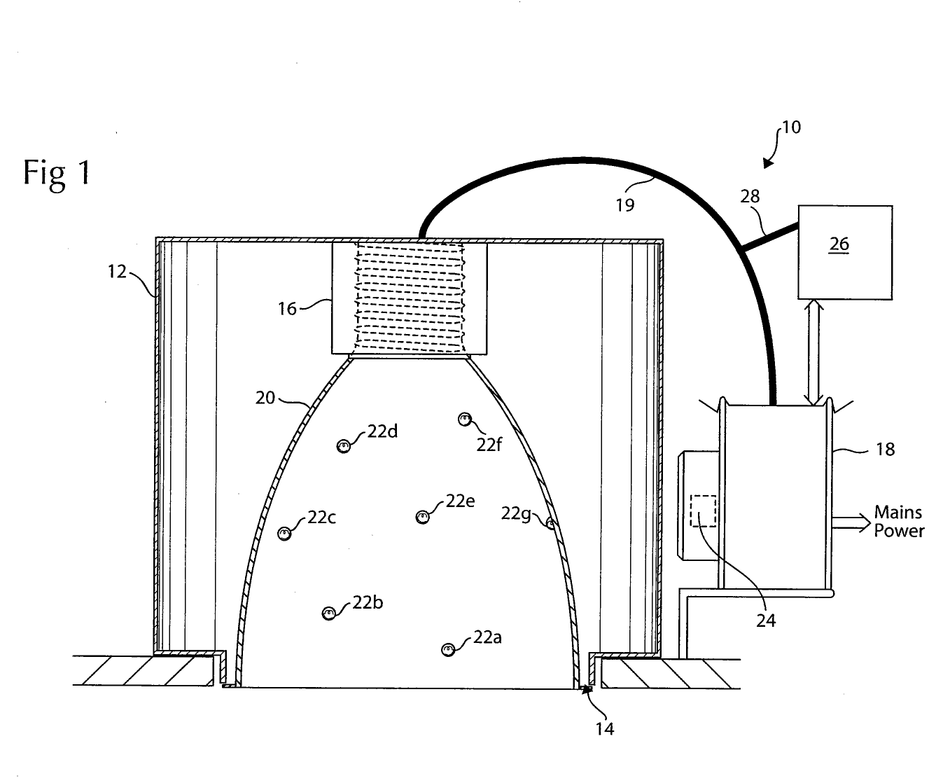

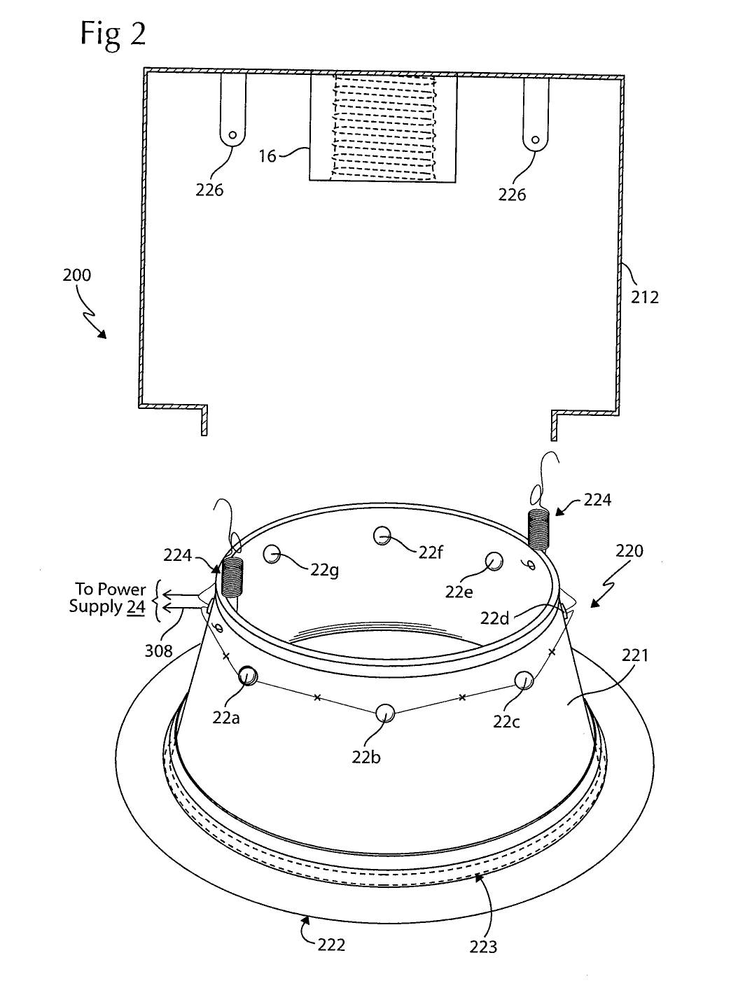

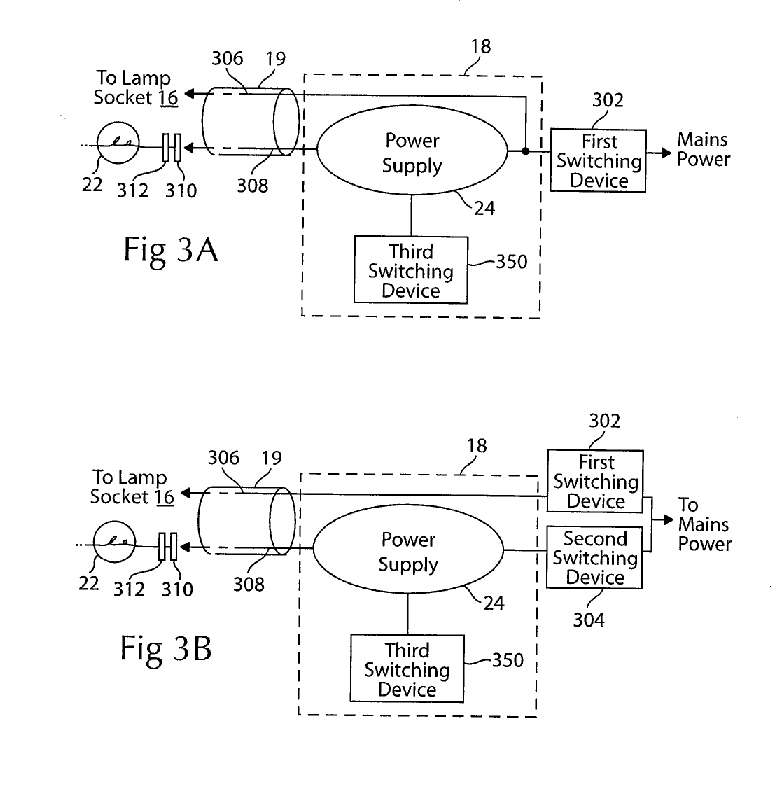

Referring now to the drawings and in particular FIG. 1, a lighting assembly suitable for implementing the present invention is designated in its entirety by the reference numeral 10. The lighting assembly 10 includes a socket housing 12, which may be a can or mounting frame (with or without walls), that defines an opening 14. The socket housing 12 includes a lamp socket 16 disposed therein such that a lamp may be installed through the opening 14 into the lamp socket 16. The lamp socket 16 is adapted to receive a conventional incandescent bulb, compact halogen bulb, or the like. The lamp socket 16 is electrically connected to an electrical junction 18 via a suitable cable bundle 19. The electrical junction 18 is electrically connected to mains power, for example, via remote sensor or a wall light switch (e.g., first switching device 302 in FIG. 3A and/or second switching device 304 in FIG. 3B). As discussed in further detail below, the cable bundle 19 may include one or more wires (e.g., wires 306 and 308 in FIGS. 3A and 3B) to provide AC or DC electrical power to the lamp socket 16 as well as other lighting elements (e.g., elements 22a-g in FIG. 1) integrated into the lighting assembly 20. As shown in FIG. 1, the lighting assembly 10 includes a trim 20, which is removably attached to the socket housing 12 about the opening 14. The trim 20 may be any type of trim commonly known in the lighting art including but not limited to a baffle, gimbal, pinhole, scoop, octagonal, cylinder, cone, thermos type trim and combinations thereof The trim 20 may be removably attached via standard fasteners, such as screws (not shown in figures) adapted to engage the trim 20 to the socket housing 12, torsion springs having legs (not shown in figures) adapted to engage the trim 20 to the opening 14 of the socket housing, or springs (e.g., springs 224 in FIG. 2) that engage the trim (e.g., trim 220 in FIG. 2) to support members (e.g., 226 in FIG. 2) affixed to the socket housing (e.g., 200 in FIG. 2).

While the figures in the present application all depict a recessed lighting embodiment for the present invention, it should be understood that the present invention can be embodied in other types of light fixtures including, but not limited to, track lighting, pendent lighting, surface mount lighting, and sconce lighting.

Referring to FIG. 1, a plurality of solid-state light emitting devices 22, including a first solid-state light emitting device 22a, is mounted to the trim 20. Each solid-state light emitting device 22a-22g may be a light-emitting diode (LED), organic light-emitting diode (OLED), polymer light-emitting diode or another type of lighting element where the light is emitted from a solid object rather than from a vacuum or gas tube, as is the case in traditional incandescent light bulbs and fluorescent lamps. Unlike traditional incandescent and even fluorescent lighting, solid-state light emitting devices create visible light with virtually no heat or parasitic energy dissipation. Solid-state light emitting devices 22 would generally have greater resistance to shock, vibration, and wear, thereby increasing their lifespan significantly.

As would be understood by those of ordinary skill in the lighting art having the present specification before them, the color of light emitted by each solid-state light emitting device 22a-22g may depend upon the use contemplated for the respective solid-state light emitting device 22a-22g. By way of example and not of limitation, in one embodiment where the solid-state light emitting devices 22a-22g would be used for emergency lighting the solid-state light emitting devices would ideally emit white light. In other embodiments where, by way of example and not of limitation, the solid-state light emitting devices 22a-22g could be used for mood, accent or lower level lighting, the solid-state light emitting devices 22a-22g could emit blue, green or other softer color light frequencies. It would similarly be understood by those of ordinary skill in the lighting art having the present specification before them, that any type of solid-state light emitting device 22a-22g may work with the present invention. It is presently believed that LEDs manufactured by Osram Sylvania or CREE, Inc. would be recommended.

In one implementation, each solid-state light emitting device 22 is mounted or otherwise physically associated with trim 20. However, in implementations in which the trim 20 is incorporated into the socket housing 12 (for example, in a track lighting housing), each solid-state light emitting device 22a-22g may be mounted on or associated with the socket housing 12. In the embodiment shown in FIG. 1, the solid-state light emitting devices 22 may be distributed throughout the trim 20.

FIG. 2 shows another potential implementation of a lighting assembly 200 in accordance with the present invention. The lighting assembly 200 includes a socket housing 12, a lamp socket 16 disposed therein, and a trim 220 having one or more solid-state light emitting devices 22, where the lamp socket and the first solid-state light emitting device 22a are operatively connected to an electrical junction 18 consistent with the lighting assembly 10. In the implementation shown in FIG. 2, the trim 220 has a trim body 221 and a trim ring 222 disposed around the trim body. The solid-state light emitting devices 22 are physically disposed in or on the trim body 221 or the trim ring 222, which in this implementation is adapted to rest on a lip 223 of the trim body 221. In this implementation, the solid-state light emitting devices 22 are distributed in a pattern (e.g., a row) around the trim 220. In addition, in the implementation shown in FIG. 2, the trim 220 is removably attached to the housing socket 212 via springs 224 attached to the trim 220 and adapted to engage support members 226 affixed to the socket housing 212. The number of solid-state light emitting devices 22 and their distribution pattern in the trim 20 of 220 in most instances is a matter of design choice. It is preferred, though not required for all applications, that the solid-state light emitting devices 22 be mounted in such a way that the solid-state lighting devices 22 would not be prominent or readily noticeable when the solid-state lighting is not emitting light (i.e., inconspicuous) to an ordinary observer giving the same amount of attention that ordinary observer would pay to a lighting assembly.

As shown in FIGS. 2, 3 and 7, at least the first solid-state light emitting device, 22a, is operatively connected to the electrical junction 18 such that it is capable of receiving a current or electrical power sufficient to operate the solid-state light emitting device 22 when the electrical junction 18 is operatively connected to mains power. Of course, as would be understood by one of ordinary skill in the lighting art having the present specification before them, operable electrical connection to each solid-state light emitting device 22a-22g would be expected. A decision to operatively connect less than all of the solid-state light emitting devices would be primarily an issue of design choice.

As shown in FIGS. 1 and 2, the lighting assembly 10 and 200 further comprises a power supply 24 operatively connected to mains power via the electrical junction 18 for providing a low voltage sufficient to generate the current or electrical power for operating the first solid-state light emitting device 22a or, alternatively, each of the solid-state light emitting devices 22a-22g mounted to the trim 20 or 220. The power supply 24 may be a standard power supply adapted to supply one or more low voltage outputs (e.g., 12 or 5 VDC) based on mains power (e.g., 120 VAC). Alternatively, the power supply 24 may be an LED driver, transformer, resistor, or other active or passive electrical component or group of components capable of converting mains power to the low (AC or DC) voltage level required to operate a respective solid-state light emitting device 22a-22g.

In one implementation shown in FIG. 3A, the lighting assembly 10 and 200 is controlled by a first switching device 302 or wall light switch, which is operatively configure to selectively supply mains power to the electrical junction 18 for both the lamp socket 16 and the power supply 24 adapted to supply the current or electrical power for operating the first solid-state emitting device 22a. Alternatively, as shown in FIG. 3B, the first switching device may selectively supply mains power to the lamp socket 16 and a second switching device may selectively supply mains power to the power supply 24 to supply the current or electrical power for operating the first solid-state emitting device 22a, such that a lamp installed in the lamp socket 16 and the first solid-state emitting device 22a may be separately controlled. In this implementation, a user may manually turn power off to the lamp socket 16 and turn power on to the first solid-state emitting device 22a to provide for a night light or low light condition. The user may also manually turn power on to both the lamp socket 16 and the first solid-state emitting device 22a so that the first solid-state emitting device 22a provides accent or mood lighting in association with the lighting provided by a lamp installed in the light socket 16.

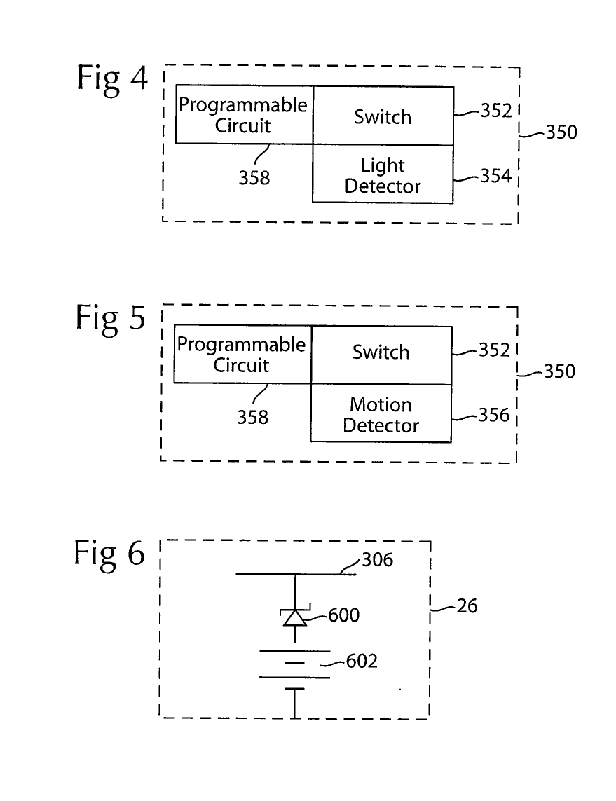

As shown in FIGS. 3A and 3B, the lighting assembly 10 or 220 may include a third switching device 350 that is operatively connected to the power supply 24 to control when current or electrical power is supplied to the first solid-state emitting device 22a (e.g., when the first solid-state emitting device 22a is turned on). In one implementation shown in FIG. 4, the third switching device 350 includes a switch 352 and a light detector 354. The switch 352 may be operatively connected between mains power and the power supply 350 or between the power supply and the first solid-state emitting device 22a. The light detector 354 is operatively configured to activate the switch 352 such that the power supply 24 provides the current or electrical power to the first solid-state emitting device 22a when the light detector 354 senses no light or substantially low level of light from a lamp installed in the lamp socket 16. In another implementation shown in FIG. 5, the third switching device 350 includes the switch 352 and a motion detector 356 operatively configured to activate the switch 352 such that the power supply 24 provides the current or electrical power to the first solid-state emitting device 22a when the motion from a person or object is detected by the motion detector 354 within a predetermined distance of the light assembly 10 and 200. In each implementation, the third switching device 350 may include a programmable circuit 358 operatively configured to enable a user to set a predetermined time (e.g., a time for each day or time for a selected day, such as a weekday) and a predetermined period for when the switch 352 is operational or capable of being activated by either a light detector 354 or motion detector 356. Thus, the lighting assembly 10 and 200 are each adapted to enable when the first solid-state light emitting device 22 is to be activated via the third switching device to function as a night light or an emergency light for egress and ingress.

As shown in FIGS. 3A and 3B, the lighting assembly 10 and 200 may each have a first connector 310 operatively connected to the cable bundle 19 and a second connector 312 operatively connected to the first solid-state light emitting device 22a mounted to the trim 20 or 220. The first connector 310 is operatively configured to mate to the second connector 312 such that the wire 308 from the power supply 24 is electrically connected to the solid-state light emitting devices 22. Although not shown in the figures, the first connector 310 and the second connector 312 may also be configured to connect the wire 306 from the mains power to the lamp socket 16. In addition, electrical return or ground lines are not shown in the figures to avoid obscuring the invention but may also be carried by the first connector 310 and the second connector 312 to complete a circuit for supplying the current or electrical power to the first solid-state light emitting device 22a.

Returning to FIG. 1, the lighting assembly 10 or 220 may also include a backup battery 26 operatively connected to the cable bundle 19 for providing the low voltage, in lieu of the power supply 24, sufficient to generate the current or electrical power for operating the solid-state light emitting devices 22. In one implementation shown in FIG. 5, the backup battery 26 includes a zener diode 600 and a battery 602. The zener diode 600 is operatively connected between the wire 306 in cable bundle 19 that supplies current to the lamp socket 16 and the battery 602. When the voltage on the wire 306 from mains power falls below a predetermined voltage level, the zener diode 600 is adapted to be forward biased and enable the battery 504 to supply current on the wire 306. Thus, the backup battery 26 enables the first solid-state light emitting device 22a to function as a night light or emergency light. In one implementation, the backup battery 26 is also operatively connected to the electrical junction 18 such that the backup battery 26 is able to sense whether mains power is being received by the power supply 24 (e.g., via a wall light switch 302 or 304) and the power supply 24 has failed or is not outputting the current or electrical power for operating the first solid-state light emitting device 22a. In this implementation, when it is determined that the power supply 24 has failed, the backup battery 26 is adapted to supply a low voltage to generate the current or electrical power for operating the first solid-state light emitting device 22a. Thus, the backup battery 26 enables the first solid-state light emitting device 22a to function as an emergency light. The battery 26 may also be rechargeable.

A method for providing alternative lighting from a lighting assembly 10 or 200 is also disclosed. The lighting assembly 10 or 200 includes a socket housing 12 having an opening 14 and having a lamp socket 16 disposed therein. The lamp socket 16 is electrically connected to an electrical junction 18. The method includes providing a trim 20 or 220 having a first solid-state light emitting device 22 mounted thereto, attaching the trim 20 or 220 to the opening 14 of the socket housing 12, and operatively connecting the first solid-state light emitting device to the electrical junction. The operatively connecting may include activating a switch 352 to enable the electrical power to reach the first solid-state light emitting device the appropriate current and the appropriate voltage. The switching may be controlled by ambient light in a room; mains power; or manually.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A lighting assembly comprising:
a socket housing defining an opening and having a lamp socket disposed therein, the lamp socket being electrically connected to an electrical junction and adapted to receive a primary lighting source;
a trim removably attached to the socket housing about the opening; and
a first solid-state light emitting device mounted to the trim, the first solid-state light emitting device being operatively connected to the electrical junction such that it is capable of receiving electrical power to cause the first solid-state light emitting device to emit light when the electrical junction is operatively connected to mains power.

2. The lighting assembly of claim 1, wherein the first solid-state light emitting device is mounted to the trim such that when the lighting assembly is installed the first solid-state light emitting device is inconspicuous to the casual observer.

3. The lighting assembly of claim 2, further comprising a power supply operatively associated to mains power for providing the electrical power to the first solid-state light emitting device.

4. The lighting assembly of claim 3, further comprising a backup battery operatively connected to the first solid-state lighting emitting device to provide the electrical power when the power supply does not.

5. The lighting assembly of claim 4, wherein the battery is rechargeable.

6. The lighting assembly of claim 3, wherein the power supply is controlled by a switch.

7. The lighting assembly of claim 6, further comprising a programmable circuit operatively configured to control the switch based on a predetermined time and a predetermined period.

8. The lighting assembly of claim 6, further comprising a motion detector operatively connected to the switch to control activation of the switch.

9. The lighting assembly of claim 6, further comprising a light detector operatively connected to the switch to control activation of the switch.

10. The lighting assembly of claim 1, wherein the first solid-state light emitting device is one of a plurality of solid-state emitting devices mounted to the trim.

11. The lighting assembly of claim 10, wherein the plurality of solid-state emitting devices are mounted in a pattern to the trim.

12. The lighting assembly of claim 1, wherein the first solid-state light emitting device is disposed in relation to the lamp socket such that the first solid-state light emitting device provides accent lighting.

13. A trim for a lighting assembly, said lighting assembly comprising a first connector, a socket housing having an opening and a lamp socket disposed therein, the first connector and the lamp socket each being electrically connected to an electrical junction, the trim comprising:
a first solid-state light emitting device mounted to the trim; and
a second connector operatively connected to mate to the first connector such that the first solid-state light emitting device is capable of receiving electrical power to cause the first solid-state light emitting device to emit light when the electrical junction is operatively connected to mains power.

14. The trim of claim 13, wherein the first solid-state light emitting device is mounted to the trim such that when the lighting assembly is installed the first solid-state light emitting device is inconspicuous to the casual observer.

15. The trim of claim 13, wherein the first solid-state light emitting device is one of a plurality of solid-state emitting devices mounted to the trim.

16. The trim of claim 15, wherein the plurality of solid-state emitting devices are mounted in a pattern to the trim.

17. The trim of claim 13, wherein trim has a trim body and a trim ring disposed around the trim body, the first solid-state emitting device being mounted to one of the trim body and the trim ring.

18. The trim of claim 13, wherein the first solid-state light emitting device is disposed in relation to the lamp socket such that the first solid-state light emitting device provides accent lighting.

19. A method for providing alternative lighting from a lighting product, the lighting product comprising a socket housing having an opening and having a lamp socket disposed therein, the lamp socket being electrically connected to an electrical junction, the method comprising:
providing a trim having a first solid-state light emitting device mounted thereto;
attaching the trim to the opening of the socket housing; and
operatively connecting the first solid-state light emitting device to the electrical junction.

20. The method of claim 19, wherein operatively connecting further includes activating a switch to enable the electrical power to reach the first solid-state light emitting device.

21. The method of claim 20, wherein the switch is activated by a programmable circuit operatively configured to activate the switch based on a predetermined time and a predetermined period.

22. The method of claim 21, wherein the switch is activated by a motion detector.

23. The method of claim 21, wherein the switch is activated by a light detector.
